(19) United States
(12) Patent Application Publication
(10) Pub. No.: US 2021/0293305 A1
(43) Pub. Date: Sep. 23, 2021

(54) PLATE LINK CHAIN HAVING A SECURING ELEMENT FORMING A PROTRUDING NOSE AS A CONTACT POINT AND METHOD FOR PRODUCING A PLATE LINK CHAIN

(71) Applicant: Schaeffler Technologies AG & Co. KG, Herzogenaurach (DE)

(72) Inventor: Alexander Gorbunov, Bühl (DE)

(73) Assignee: Schaeffler Technologies AG & Co. KG, Herzogenaurach (DE)

(21) Appl. No.: 17/257,669

(22) PCT Filed: Jul. 15, 2019
(86) PCT No.: PCT/DE2019/100653

§ 371 Date: Jan. 4, 2021

(30) Foreign Application Priority Data
Jul. 18, 2018 (DE) 10 2018 117 404.7

(51) Int. Cl. F16G 13/06; F16G 15/02; F16G 15/12

(52) U.S. Cl. CPC F16G 13/06; F16G 15/12; F16G 15/02

(57) ABSTRACT

A plate link chain for a continuously variable transmission having cone pulleys includes a plurality of plates arranged transverse to a wrap-around direction of the plate link chain, a rocker pin and a securing element. The rocker pin extends transverse to the wrap-around direction, connects the plurality of plates to one another, and is arranged to absorb a force applied by the cone pulleys. The securing element is welded onto the rocker pin, forms a stop for a one of the plurality of plates transverse to the wrap-around direction, and has a nose protruding transverse to the wrap-around direction. The nose defines a contact point between the securing element and the one of the plurality of plates.

### CROSS-REFERENCE TO RELATED APPLICATIONS

This application is the United States National Phase of PCT Appln. No. PCT/DE2019/100653 filed Jul. 15, 2019, which claims priority to German Application No. DE102018117404.7 filed Jul. 18, 2018, the entire disclosures of which are incorporated by reference herein.

### TECHNICAL FIELD

The disclosure relates to a plate link chain, also known as a CVT chain, designed to move along a wrap-around direction in a CVT transmission. The plate link chain has cone pulleys, a plurality of plates, arranged along the wrap-around direction and transversely to the wrap-around direction, and a plurality of rocker pins connecting the plates to one another. The plurality of rocker pins extend transversely to the wrap-around direction, and are designed to absorb a force applied by the cone pulleys and thus to transmit a torque. The plate link chain also has at least one securing element welded onto one of the rocker pins in order to form a stop for one of the plates transversely to the wrap-around direction. A securing element may be welded onto each rocker pin.

### BACKGROUND

Plate link chains of the generic type for use in CVT transmissions are known from the prior art. Continuously variable transmissions (CVT transmissions) are continuously adjustable transmissions in which at least two cone pulleys can be moved relative to one another along their axes of rotation in order to change/adjust a transmission ratio. The torque is transmitted via the plate link chain, which is why the plate link chain in general and the securing elements in particular are subjected to high stresses.

Generic securing elements are generally made of soft steel in order to require as little energy as possible for the melt formation during the welding process on the respective rocker pin. In addition, the softer material prevents the plate from being roughened/damaged during operation.

From DE 101 10 896 A1 a plate link chain is known in which a securing element is welded onto the rocker pin as a stop for the respective plates for each rocker pin. The geometry of the securing elements is cylindrical, (partially) spherical, or cuboid and forms a beaded weld seam. The alignment of the securing element changes depending on the precision of the weld seam, which affects the robustness of the respective stop for the plates.

Another link chain is disclosed in DE 44 15 838 C1. It has up to two securing elements per rocker pin in order to increase the robustness of the stop. The problem mentioned above, namely that, in practice, different stresses are placed on the respective stop for the plates, depending on the precision of the weld seam, is not remedied by the solution from DE 44 15 838 C1.

Further plate link chains are known from the documents DE 35 26 062 A1 and DE 102 03 942 A1.

Despite the many known plate link chains, the problem continues to present itself in the prior art that securing elements become detached from the rocker pin, potentially resulting in the plate link chains falling apart (during transport or even during operation). The root cause of that problem lies in the fact that the deformations or the alignment of the securing element cannot be controlled by the welding process.

### SUMMARY

The present disclosure provides a plate link chain that eliminates or at least reduces the risk of the securing element becoming detached from the rocker pin.

According to the disclosure, a securing element, on its side facing the plate, forms a nose protruding transversely to the wrap-around direction that defines a contact point (or contact area) for the stop between the securing element and the plate. Due to this defined contact area, the load that acts on the securing element from the plate is predictable, eliminating the risk of the securing element breaking off due to an unexpectedly high load.

In functional terms, the securing element according to the disclosure has a geometry which scalably defines a load introduction of the plate onto the securing element. Before the securing element is welded onto the rocker pin, the securing element has a non-cylindrical shape for this purpose, which is embossed, punched, or wire-drawn, for example. The securing element has projections which are adapted for (essentially point-like) contact with the plate. Thus, according to the disclosure, the position of the lever arm of the contact point is reduced. The welding surface may also have defined melting points, further promoting the defined introduction of force through the plate.

For example, the protruding nose may be formed by two opposing portions, which are flat at least in portions. In this way, the contact point between the nose and the plate is precisely determined, preventing excessive torques from being applied to the securing element.

Before it is welded onto the rocker pin, the securing element may have at least two feet or foot portions which are spaced apart from one another along the wrap-around direction and which represent defined melting points between the securing element and the rocker pressure portion and thus allow for a weld seam that protrudes to a smaller extent compared to the protruding nose. This prevents the plate from contacting the weld seam, increasing the strength and robustness of the plate link chain.

In this embodiment, the securing element may have four feet before it is welded onto the rocker pin, two of which feet are spaced apart along the wrap-around direction and two of which feet are spaced apart transversely to the wrap-around direction, so that a cruciform gap is defined between the four feet, into which the melt escapes during welding. This is favorable for the dimension of the weld seam so that its bead is further reduced.

In an example embodiment, when the protruding nose is arranged in the lower half in the securing element height direction, e.g., in the lower third, of the securing element, the lever arm of the torque input from the plate to the securing element can be effectively lowered, further reducing the susceptibility of the securing element to breakage.

In a further embodiment, a centering portion of the securing element facing away from the rocker pin has a tapering geometry in order to allow for centering of a welding electrode. A roof-shaped, cone (cylinder) shaped or a combination of both geometries lends itself to the geometry. Thus, the welding process can be carried out within a shorter time, and the weld seam is uniform because the securing element is always welded in the same orientation, avoiding weak points in the weld seam.

In this exemplary embodiment, the centering portion may have the form of a roof, tapering both along the wrap-around direction and transversely to the wrap-around direction. This makes centering easier during welding.

The securing element may be welded to the rocker pin on an effective area facing the rocker pin that has an essentially square shape. The square basic shape increases the tilting moment with which the securing element counteracts a force applied by the plate.

The disclosure also includes a method for producing a plate link chain. A plate link chain according to this disclosure may be produced by means of the method according to the disclosure. The method according to the disclosure includes the following steps:
providing plates and rocker pins,
providing a wire,
cutting the wire into several cylindrical or polygonal portions, for example,
reshaping the wire such that it takes on the form of a securing element, having a nose protruding transversely to the wrap-around direction as well as at least two feet, and
welding the securing element onto or with one of the rocker pins in order to form a stop for one of the plates transversely to the wrap-around direction.

This method allows the securing element to be held securely in a few steps. For example, the method may provide economical production of the plate link chain for large quantities.

In an example embodiment, the method according to the disclosure has an embossing step as the reshaping step. This enables a precise and scalable manufacture/production of the securing element by means of a stamp formed as a corresponding negative.

In other words, the disclosure (device and/or method) aims to precisely define the securing element by means of a nose/tip-like geometry, a load introduction by a plate.

For this purpose, the securing element has a non-cylindrical shape before welding. This shape can be embossed, punched, ground, machined, eroded, 3D printed, or produced using other machining processes. As a result, the securing element has a nose/projection/tip which defines two lever arms, as will be explained below. The nose is designed to minimize the lever arm of a bending load by the plate. However, the lever arm is not designed so small that a rounded contour of the plate serves as a point of attack for the application of force from the plate to the securing element. Rather, the contact of the securing element with the plate takes place on a flat surface of the plate in order to prevent jamming between the securing element and the plate.

Furthermore, sufficient space must be ensured for the melt leakage that occurs during welding, e.g., under the nose. Otherwise a solidified droplet could contact the plate, potentially resulting in jamming.

The geometry below the nose may define open spaces (in the form of bevels, recesses, etc.) in order to be able to absorb the melt leakage that occurs during welding and to reduce the flow speed of the melt. This prevents the melt from splashing out and improves the quality of the chain.

The stability of the securing element on the rocker pin may be improved by two feet prior to the welding current pulse.

The method according to this disclosure provides a manufacturing process that is robust or insensitive to fluctuations in the blank volume. If the volume of the blank becomes too large, the material partially flows into the joint and the contact point remains on the defined point in the radial direction, and if the volume of the blank becomes too small, the lever arms change only minimally.

### BRIEF DESCRIPTION OF THE DRAWINGS

The disclosure is explained below with reference to the accompanying figures. In the figures:

FIG. 1 shows a schematic plan view of a plate link chain;

FIG. 2 shows a securing element on a rocker pin before a welding process in a perspective view;

FIG. 3 shows the securing element from FIG. 2 in two different side views;

FIG. 4 shows the securing element on the rocker pin after the welding process in a perspective view;

FIG. 5 shows the securing element from FIG. 4 in two different side views;

FIG. 6 shows a further depiction of the securing element on the rocker pin;

FIG. 7 shows a first comparison of the securing element according to the disclosure with a securing element known from the prior art;

FIG. 8 shows a further comparison of the securing element according to the disclosure with a securing element known from the prior art;

FIG. 9 shows a further comparison of the securing element according to the disclosure with a securing element known from the prior art;

FIG. 10 shows a further comparison of the securing element according to the disclosure with a securing element known from the prior art;

FIG. 11 shows the securing element in a side view;

FIG. 12 shows the securing element in a further side view;

FIG. 13 shows method steps for producing the securing element;

FIG. 14 shows a perspective view and two side views of a securing element in a further embodiment; and

FIG. 15 shows a perspective view and two side views of a securing element in a further embodiment.

### DETAILED DESCRIPTION

The figures are only schematic in nature and serve only for understanding the disclosure. The same components are provided with the same reference symbols.

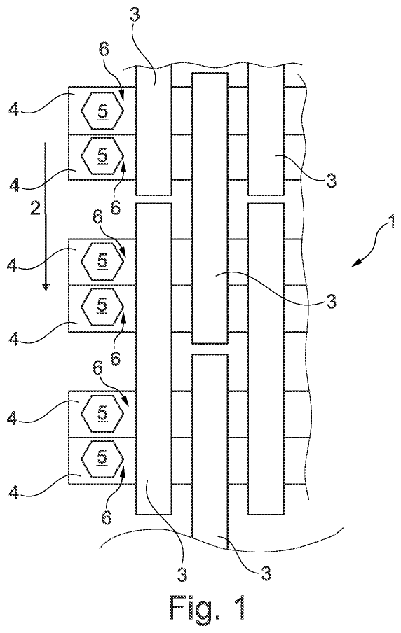

FIG. 1 shows a plate link chain 1 for a CVT transmission (not shown) extending along a wrap-around direction 2. The plate link chain 1 has a plurality of plates 3 which are arranged along the wrap-around direction 2 and transversely to the wrap-around direction 2. In addition to the plates 3, the plate link chain 1 has a plurality of rocker pins 4 which, extending transversely to the wrap-around direction 2, connect the plates 3 to one another. The rocker pins 4 absorb a force supplied by cone pulleys (not shown) during operation of the CVT transmission. The plate link chain 1 also has a securing element 5, which is welded onto one of the rocker pins 4 in order to form a stop for one of the plates 3 transversely to the wrap-around direction 2.

The securing element 5 forms, at least on its side facing the plate 3, a nose 6 which protrudes transversely to the wrap-around direction 2 and defines a contact point between the securing element 5 and the plate 3 for the stop. The area defined by the contact point is small compared to the side surface of the securing element 5.

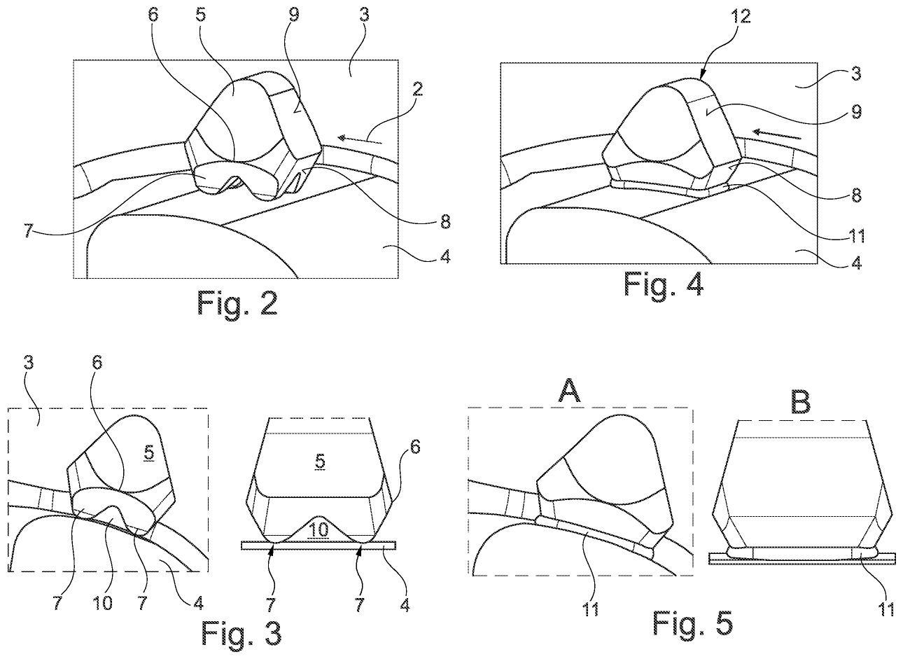

FIG. 2 shows the securing element 5 in a state before it is welded onto the rocker pin 4. The securing element 5 is designed mirror-symmetrically so that a protruding nose 6 is also formed on the side facing away from the plate 3. In the state before welding, the securing element 5 has feet 7 (welding feet) which ensure a defined contact surface between the securing element 5 and the rocker pin 4 and which feet have a favorable effect on the melt leakage. In the present disclosure, the securing element 5 has four feet 7.

The securing element 5 has a roof shape in the upper portion so that the nose 6 in the present disclosure is formed from two flat portions running in opposite directions; a lower flat portion 8, and an upper flat portion 9.

FIG. 3 shows the securing element 5 from FIG. 2 in a view transverse to the wrap-around direction 2 (left) and a view along the wrap-around direction 2 (right). A gap 10 is formed between the feet 7. The melt escapes into this gap 10 during welding so that a weld seam 11 (see, for example, FIG. 4) forms a bead that is small compared to the volume of the securing element 5.

FIGS. 4 and 5 show the securing element 5 in a state after it has been welded onto the rocker pin 4. Instead of the feet 7, a weld seam 11 represents the contact between the securing element 5 and the rocker pin 4. The upper part of the securing element 5 is furthermore designed as a centering portion 12, which simplifies the application of a welding electrode. The remaining components from FIGS. 4 and 5 are already known from FIGS. 2 and 3 and will not be described again here to avoid repetition.

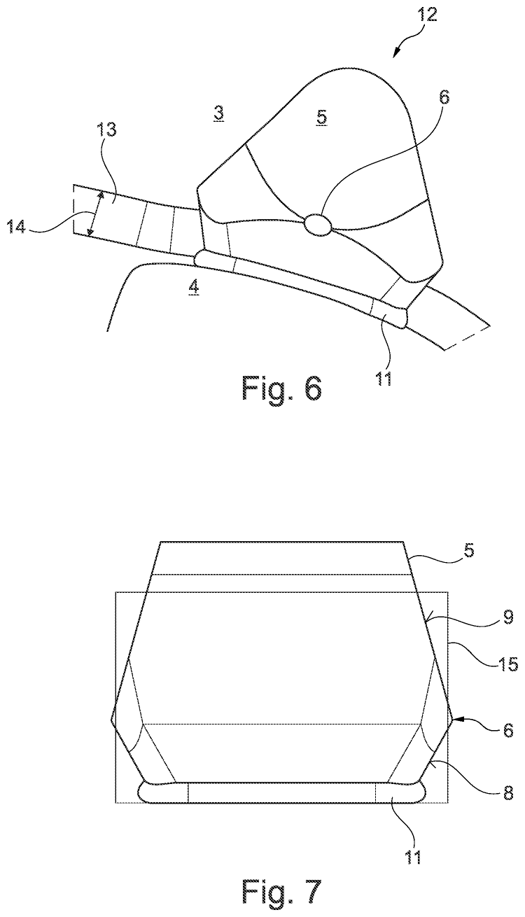

In FIG. 6 the securing element 5 is shown in a view transverse to the wrap-around direction 2. The weld seam 11 runs flat on the rocker pin 4. The protruding nose 6 is in contact with the plate 3. The plate 3 has a rounded portion 13 in order to promote the introduction of force from the rocker pin 4 into the plate 3. Said rounded portion has a rounded portion height 14. The geometry of the securing element 5 is such that the protruding nose 6 is arranged at a height which exceeds the height of the rounded portion 14. This ensures that the nose 6 contacts the plate 3 at its flat portion and not the rounded portion 13.

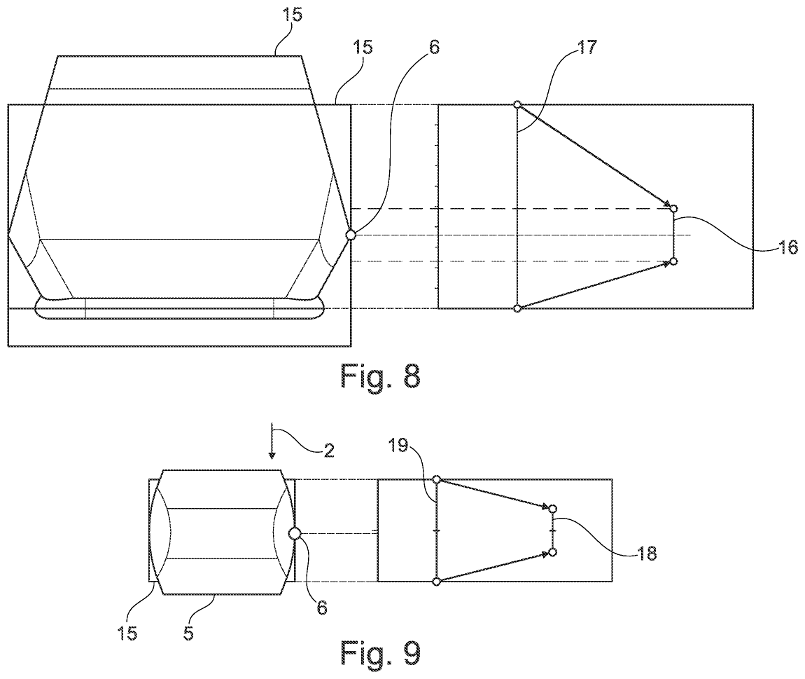

FIGS. 7 to 10 each show a comparison of the securing element 5 according to this disclosure with a cylindrical securing element 15, as is known from the prior art. FIG. 7 shows the securing element 5 in a side view. The protruding nose 6 allows for a small-area contact of the securing element 5 with the plate 3 (not shown here), compared with the cylindrical securing element 15. FIG. 8 shows the lever arm span 16 optimized according to the disclosure, in which a torque is transmitted between rocker pin 4 and plate 3, schematically compared to a lever arm span 17 according to the prior art. The contours of the securing elements 5, 15 (as in FIG. 7) are shown on the left, while the lever arm spans 16, 17 resulting therefrom are visualized on the right. Because of the protruding geometry of the nose 6, even in the event of a plastic deformation of the securing element 5, which is usually made of soft material, only a small lever arm span 16 results according to the disclosure.

FIG. 9 (essentially constructed like FIG. 8) shows that the securing element 5 also has a curved shape along the wrap-around direction 2 in order to also reduce a tilting torque span. Thus, a second lever arm span 18 according to the disclosure is reduced compared to a second lever arm span 19, as implemented by cylindrical securing elements.

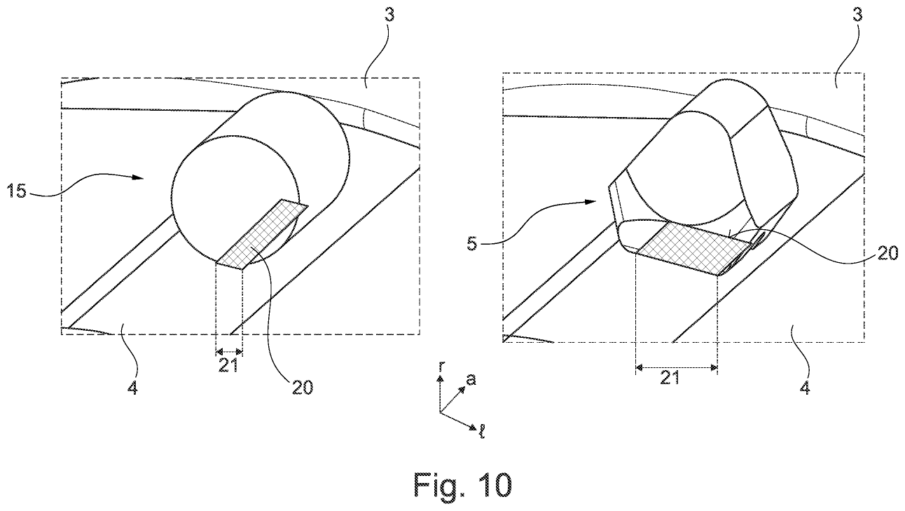

Lastly, in FIG. 10, a cylindrical securing element 15 and the securing element 5 are compared in a perspective view before welding. An effective area 20 of the securing element 5 (right) exceeds an effective area 20 of the cylindrical securing element 15 (left) and is unidirectionally robust against tilting/twisting due to its approximately square shape. Thus, a width 21 of the right effective area 20 is larger than a width 21 of the left effective area 21. The other components from FIG. 10 have already been explained and will not be elaborated here again.

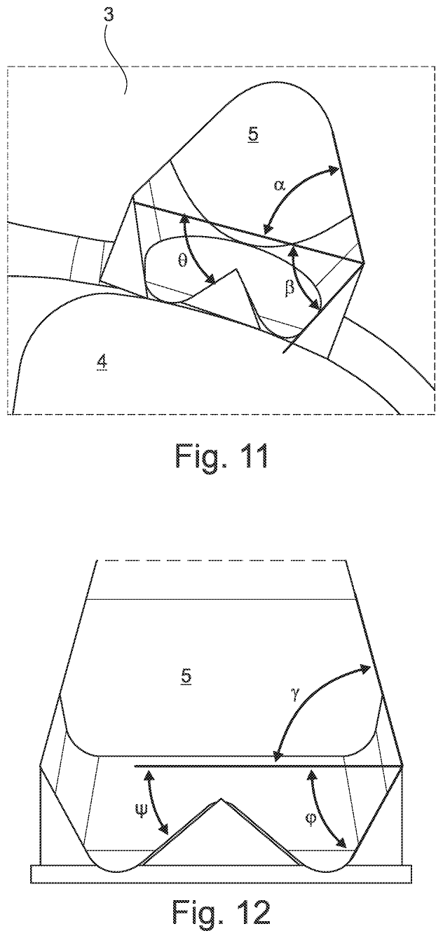

FIGS. 11 and 12 represent the securing element 5 transversely to the wrap-around direction 2 (FIG. 11) and along the wrap-around direction 2 (FIG. 12). The angles α, β, θ, γ, φ, and ψ are each between 0 and 87°. Furthermore, they are to be adapted in such a way that, on the one hand, the melt leakage is promoted and, on the other hand, a sufficient effective area 20 is made possible.

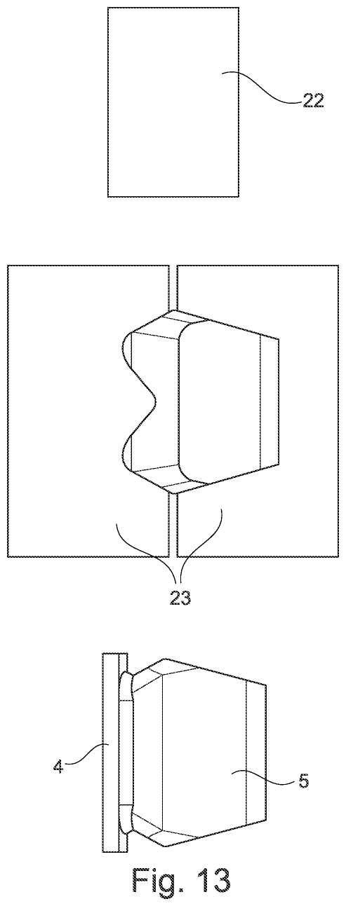

In FIG. 13 the method for producing the securing element 5 is shown schematically. First, a wire 22 is taken, which is then cut into individual pieces (top). The wire 22 is then embossed by means of an embossing tool 23 (center) in order to obtain the securing element 5 with feet 7. Lastly, the securing element 5 is welded onto the rocker pin 4 (below).

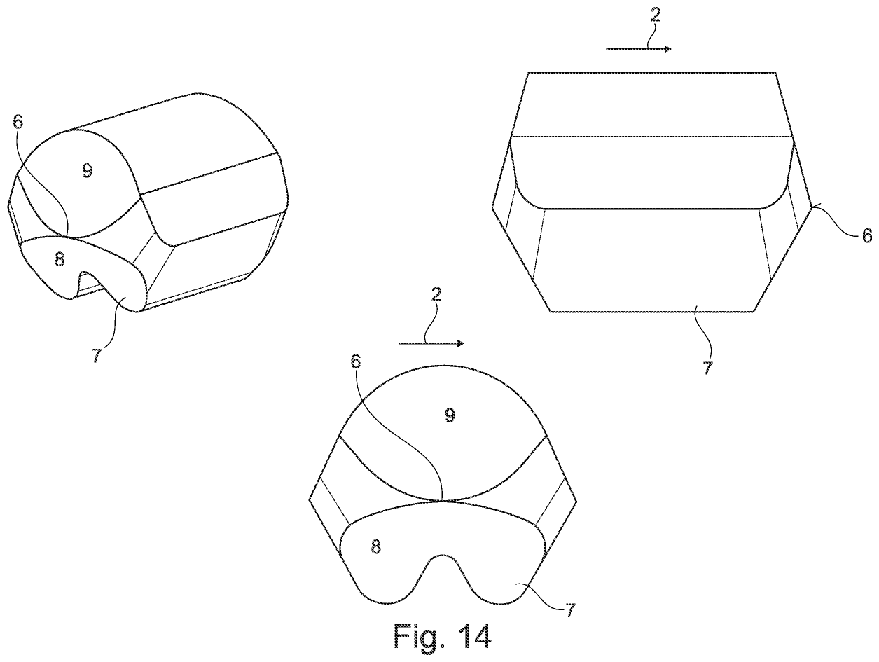

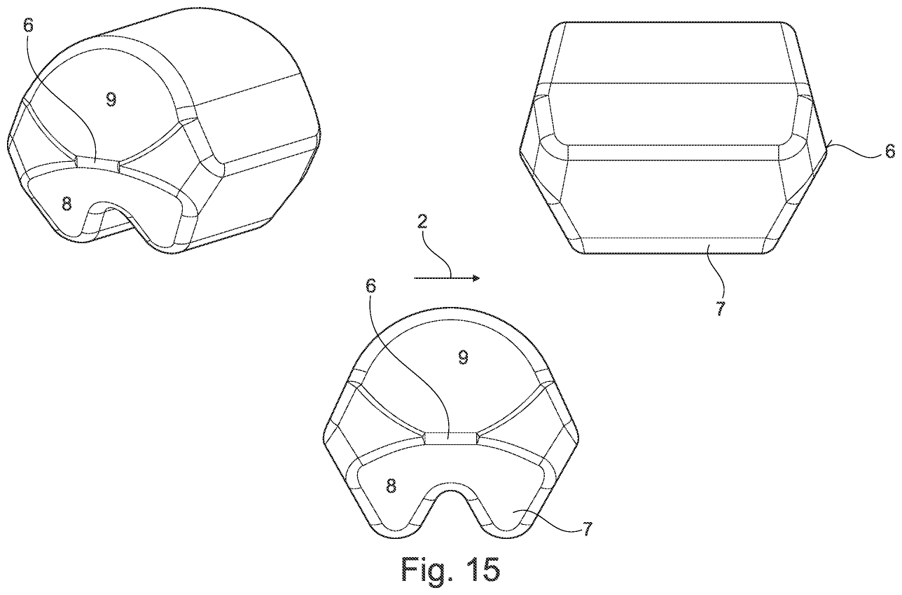

FIGS. 14 and 15 show two embodiments of the securing element 5, each having two rail-like feet 7. Respectively, a perspective view is shown on the left, while a view transverse to the wrap-around direction 2 is shown in the center, and a view along the wrap-around direction 2 is shown on the right. In FIG. 14, the transitions of the individual portions of the securing element 5 are designed with sharp edges. In FIG. 15, the respective transitions are rounded, which makes handling the securing element 5 easier.

### REFERENCE NUMERALS

1 Plate link chain
2 Wrap-around direction
3 Plate
4 Rocker pin
5 Securing element
6 Protruding nose
7 Foot
8 Lower flat portion
9 Upper flat portion
10 Gap
11 Weld seam
12 Centering portion
13 Rounded portion
14 Rounded portion height
15 Cylindrical securing element
16 Lever arm span between the plate and the rocker pin
17 Lever arm span from the prior art
18 Second lever arm span between the plate and the rocker pin
19 Second lever arm span from the prior art
20 Effective area
21 Width
22 Wire
23 Embossing tool

1.-10. (canceled)

11. A plate link chain for a continuously variable transmission comprising cone pulleys, comprising:
a plurality of plates arranged transverse to a wrap-around direction of the plate link chain;
a rocker pin:
extending transverse to the wrap-around direction;
connecting the plurality of plates to one another; and
arranged to absorb a force applied by the cone pulleys; and
a securing element:
welded onto the rocker pin;
forming a stop for a one of the plurality of plates transverse to the wrap-around direction; and
comprising a nose protruding transverse to the wrap-around direction, the nose defining a contact point between the securing element and the one of the plurality of plates.

12. The plate link chain according of claim 11, wherein the nose is formed by two opposing portions comprising respective flat portions.

13. The plate link chain of claim 11, wherein, prior to being welded onto the rocker pin, the securing element comprises at least two feet spaced apart from one another along the wrap-around direction that are melted when the securing element is welded onto the rocker pin.

14. The plate link chain of claim 13 wherein, after being welded onto the rocker pin, a weld seam formed by the at least two feet protrudes less than the nose transverse to the wrap-around direction.

15. The plate link chain of claim 13, wherein, prior to being welded onto the rocker pin:
the securing element comprises four feet;
a first two of the four feet are spaced apart in the wrap-around direction;
a second two of the four feet are spaced apart transverse to the wrap-around direction;
a cruciform gap is defined between the four feet; and
a melt extends into the cruciform gap when the securing element is welded onto the rocker pin.

16. The plate link chain of claim 11, wherein:
the securing element comprises a height extending from the rocker pin; and
the nose is arranged in a lower half of the height.

17. The plate link chain of claim 11, wherein:
the securing element comprises a centering portion facing away from the rocker pin; and
the centering portion comprises a tapering geometry for centering of a welding electrode.

18. The plate link chain of claim 17, wherein the centering portion comprises a roof shape that:
tapers along the wrap-around direction; and
tapers transverse to the wrap-around direction.

19. The plate link chain of claim 11, wherein a welded area between the securing element and the rocker pin is essentially square.

20. A method for producing the plate link chain of claim 11, comprising:
providing the plurality of plates and the rocker pin;
providing a wire;
cutting the wire into a wire portion;
reshaping the wire portion to form the securing element; and
welding the securing element onto the rocker pin to form the stop.

21. The method of claim 20 wherein the reshaping is performed by embossing the wire portion.

22. The method of claim 20 wherein the wire portion is cylindrical.
